(19) United States
(12) Patent Application Publication
(10) Pub. No.: US 2017/0215414 A1
(43) Pub. Date: Aug. 3, 2017

(54) BIOCIDAL COMPOSITIONS AND METHODS

(71) Applicant: Jerry BOND, Dacula, GA (US)

(72) Inventor: Jerry BOND, Dacula, GA (US)

(21) Appl. No.: 15/421,841

(22) Filed: Feb. 1, 2017

Related U.S. Application Data
(60) Provisional application No. 62/289,451, filed on Feb. 1, 2016.

(51) Int. Cl. A01N 31/16; A01N 49/00; A01N 25/02; A01N 65/24; A01N 65/22; A01N 25/30; A01N 65/16; A01N 37/10

(52) U.S. Cl. CPC A01N 31/16; A01N 65/16; A01N 49/00; A01N 37/10; A01N 65/24; A01N 65/22; A01N 25/30; A01N 25/02

(57) ABSTRACT

A biocidal composition including one or more of an ester, a phenylpropanoid, a surfactant, a monoterpenoid, an oil, a preservative, and a carrier is described, the composition being capable to act as a biocide for bedbugs, dust mite, spiders, fleas, ticks, mosquitoes, silver fish, and roaches.

### CROSS-REFERENCE TO RELATED APPLICATION

This application claims the benefit of U.S. Provisional Patent Application No. 62/289,451, filed Feb. 1, 2016 entitled “Biocidal Compositions and Methods,” which is incorporated by reference herein in its entirety.

### BACKGROUND OF THE INVENTION

Controlling insect population is essential to modern agriculture, food storage, and hygiene. Currently, safe and effective encapsulated insecticidal formulations play a significant role in controlling insect populations. Properties of useful encapsulated insecticidal formulations include good efficacy against targeted pests, including good initial toxicity against targeted insects, ease of handling, stability, advantageous residence times in the environment and, in some instances, a long effective period of insecticidal activity after its application to an area adjacent to a population of insects.

Unfortunately, most insecticide formulations, especially liquid-based preparations, lose their efficacy relatively soon after their application. Such insecticide formulations must, therefore, be reapplied to ensure insect control. Additionally, formulations with a short period of post-application activity may result in periods of time during which a surface adjacent to a population of insects is vulnerable to infestation. This creates a need to periodically apply various insecticidal formulations in order to control continuing pest infestations or to prevent their occurrence, increase the amount of insecticides that must be used, and the increased cost associated with their shipping, handling and application.

### BRIEF SUMMARY OF THE INVENTION

According to an embodiment, a composition includes one or more of: (A) an ester, (B) a compound from the class of phenylpropanoids, (C) a first surfactant, (D) a monoterpenoid, (E) one or more oils, (F) optionally a second surfactant, (G) a preservative, and (H) a carrier. In one embodiment, the invention relates to a composition including one or more of an ester, a phenylpropanoid, a surfactant, a monoterpenoid, an oil, a preservative, and a carrier. In one embodiment, the composition includes an additional surfactant. In some embodiments, the ester is phenethyl propionate. In other embodiments, the phenylpropanoid is eugenol. In some embodiments, the surfactant is sodium laurel sulfate. In other embodiments, the monoterpenoid is geraniol. In some embodiments, the oil is cinnamon oil or peppermint oil. In other embodiments, the preservative is sodium benzoate. In some embodiments, the carrier is deionized water. In some embodiments, the additional surfactant is coco glucoside. In some embodiments, the composition is used as a biocide or a cleaning agent.

In one embodiment, the invention relates to a composition including or consisting essentially of from 0.0 to 5.0 wt % 2-phenethyl propionate, from 0.0 to 2.0 wt % eugenol, from 0.0 to 2.0 wt % sodium laurel sulfate, from 0.0 to 2.0 wt % geraniol, from 0.0 to 2.0 wt % cinnamon oil, from 0.0 to 5.0 wt % peppermint oil, from 0.0 to 1.0 wt % coco glucoside, from 0.0 to 8.0 wt % sodium benzoate, and the balance to 100.0 wt % deionized water. In some embodiments, the composition includes from 1.0 to 5.0 wt % 2-phenethyl propionate, from 0.1 to 1.0 wt % eugenol, from 0.5 to 2.0 wt % sodium laurel sulfate, from 0.01 to 0.5 wt % geraniol, from 0.01 to 0.5 wt % cinnamon oil, from 0.1 to 5.0 wt % peppermint, from 0.001 to 1.0 wt % coco glucoside, from 1.0 to 8.0 wt % sodium benzoate, and the balance to 100.0 wt % deionized water. In some embodiments the composition further comprises or consists essentially of about 0.01 wt % to about 1.0 wt % eucalyptus lemon fragrance, about 0.01 wt % to about 1.0 wt % thymol, and about 0.01 wt % to about 1.0 wt % NEEM. In some embodiments, the composition is used as a biocide for bedbugs, dust mite, spiders, fleas, ticks, mosquitoes, silver fish, and roaches.

In one embodiment, the invention relates to a biocidal method including the step of applying to a surface a composition including an ester, a phenylpropanoid, a surfactant, a monoterpenoid, an oil, a preservative, and a carrier. In some embodiments, the composition includes or consists essentially of from 0.0 to 5.0 wt % 2-phenethyl propionate, from 0.0 to 2.0 wt % eugenol, from 0.0 to 2.0 wt % sodium laurel sulfate, from 0.0 to 2.0 wt % geraniol, from 0.0 to 2.0 wt % cinnamon oil, from 0.0 to 5.0 wt % peppermint, from 0.0 to 1.0 wt % coco glucoside, from 0.0 to 8.0 wt % sodium benzoate, and the balance to 100.0 wt % deionized water. In some embodiments, the composition includes or consists essentially of from 1.0 to 5.0 wt % 2-phenethyl propionate, from 0.1 to 1.0 wt % eugenol, from 0.5 to 2.0 wt % sodium laurel sulfate, from 0.01 to 0.5 wt % geraniol, from 0.01 to 0.5 wt % cinnamon oil, from 0.1 to 5.0 wt % peppermint, from 0.001 to 1.0 wt % coco glucoside, from 1.0 to 8.0 wt % sodium benzoate, and the balance to 100.0 wt % deionized water. In some embodiments, the method further includes the step of removing at least a portion of the composition from the surface after a time period. In some embodiments, the composition is used as a biocide for bedbugs, dust mite, spiders, fleas, ticks, mosquitoes, silver fish, and roaches.

### DETAILED DESCRIPTION OF THE INVENTION

In some embodiments, a composition of the present invention is suitable for use as a biocide, and in particular an insecticide. Insects which may be particularly susceptible to the biocidal effects resultant from exposure to a composition of the present invention include: bedbugs, dust mite, spiders, fleas, ticks, mosquitoes, silver fish and roaches. The present invention can be used as a residential or botanical biocide. In certain embodiments, a composition of the present invention can also be used as a surface cleaning composition. Compositions, systems, and methods of the invention provide a green approach to biocides.

### Compositions

In certain embodiments, a composition of the present invention includes a carrier which can be a deionized water solution which can include an alcohol (e.g., isopropanol), in an amount of about 0.1 wt %, about 0.2 wt %, about 0.3 wt %, about 0.4 wt %, about 0.5 wt %, about 0.6 wt %, about 0.7 wt %, about 0.8 wt %, about 0.9 wt % or about 1.0 wt %. An alcohol may be present in such carrier in a range of from 0.0 wt % to 1.0 wt %. Such compositions may also include a scented oil (e.g., cinnamon or wintergreen oil) in an amount of about 0.01 wt %, about 0.02 wt %, about 0.04 wt %, about 0.08 wt %, about 0.12 wt %, about 0.15 wt %, or about 2.0 wt %. The oil may also be present in a range of from 0.0 wt % to 2.0 wt %.

The carrier can be used alone or in combination with a biocidal composition of the present invention. In an embodiment, a biocidal composition of the present invention includes one or more of: (A) an ester, (B) a compound from the class of phenylpropanoids, (C) a first surfactant, (D) a monoterpenoid, (E) one or more oils, (F) a second surfactant, (G) a preservative, (H) a carrier. In another embodiment, a composition includes one or more of an ester, a phenylpropanoid, a surfactant, a monoterpenoid, an oil, a preservative, and a carrier. Each is described in more detail hereafter.

### Ester

The present invention may include an ester. In certain embodiments the ester can be an ester of propionic acid (e.g., 2-phenethyl propionate, or 2-phenylethyl propionate).

If present, such ester may be present in an amount of: about 0.4 wt %, about 0.8 wt %, about 1.2 wt %, about 1.6 wt %, about 2.0 wt %, about 2.4 wt %, about 2.8 wt %, about 3.2 wt %, about 3.6 wt %, about 4.0 wt %, about 4.4 wt %, about 4.8 wt % or about 5.0 wt %. In some embodiments, an ester can be present in an amount of at least 0.4 wt %. In some embodiments, an ester can be present in an amount of about 0.4 wt % to about 5.0 wt %, about 0.4 wt % to about 2.4 wt %, about 0.4 wt % to about 1.2 wt %, about 1.2 wt % to about 3.6 wt %, about 1.2 wt % to about 5.0 wt %, about 2.4 wt % to about 5.0 wt % or about 3.6 wt % to about 5.0 wt %.

### Phenylpropanoid

The present invention may include a phenylpropanoid. In some embodiments, the phenylpropanoid can be one or more of an allyl chain-substituted guaiacol, an extract of clove oil, nutmeg, cinnamon, basil or bay leaf, or a combination thereof. In some embodiments, the phenylpropanoid is phenylpropene or eugenol.

If present, such phenylpropanoid may be present in an amount of: about 0.2 wt %, about 0.4 wt %, about 0.6 wt %, about 0.8 wt %, about 1.0 wt %, about 1.2 wt %, about 1.4 wt %, about 1.6 wt %, or about 2.0 wt %. In some embodiments, a phenylpropanoid can be present in an amount of at least 0.2 wt %. In some embodiments, a phenylpropanoid can be present in an amount of about 0.2 wt % to about 2.0 wt %, about 0.2 wt % to about 1.0 wt %, about 0.2 wt % to about 0.6% wt %, about 0.6 wt % to about 1.6 wt %, about 0.6 wt % to about 2.0 wt %, about 1.6 wt % to about 2.0 wt % or about 0.1 wt % to about 4.0 wt %

### Surfactants

The present invention may include a surfactant. In some embodiments, the surfactant can be one or more of: polysorbates (Tween™), sodium dodecyl sulfate (sodium lauryl sulfate), lauryl dimethyl amine oxide, cetyltrimethylammonium bromide (CTAB), polyethoxylated alcohols, polyoxyethylene sorbitan, octoxynol (Triton X100™), N,N-dimethyldodecylamine-N-oxide hexadecyltrimethylammonium bromide (HTAB), polyoxyl 10 lauryl ether, Brij 721™, bile salts (sodium deoxycholate, sodium cholate), polyoxyl castor oil (Cremophor™), nonylphenol ethoxylate (Tergitol™), cyclodextrins, lecithin, and methylbenzethonium chloride (Hyamine™).

If present, a first surfactant may be present in an amount of about 0.2 wt %, about 0.4 wt %, about 0.5%, about 0.6 wt %, about 0.8 wt %, about 1.0 wt %, about 1.1 wt. %, about 1.2 wt %, about 1.3 wt. %, about 1.4 wt %, about 1.5 wt %, about 1.6 wt %, or about 2.0 wt %. In some embodiments, a surfactant can be present in an amount of at least 0.2 wt %. In some embodiments, a first surfactant can be present in an amount of about 0.2 wt % to about 2.0 wt %, about 0.2 wt % to about 1.0 wt %, about 0.2 wt % to about 0.6% wt %, about 0.6 wt % to about 1.6 wt %, about 0.6 wt % to about 2.0 wt %, about 1.6 wt % to about 2.0 wt % or about 0.1 wt % to about 4.0 wt %.

In some embodiments, the present invention can include a second surfactant. In such embodiments, the second surfactant can be ionic or non-ionic. In some embodiments, the non-ionic surfactant can be one or more of coco-glucoside, lauryl glucoside, or octyl glucoside.

If present, a second surfactant can be present in an amount of about 0.001 wt %, about 0.002 wt %, about 0.004 wt %, about 0.006 wt %, about 0.008 wt %, about 0.1 wt %, about 0.2 wt %, about 0.4 wt %, about 0.6 wt %, about 0.8 wt %, or about 1.0 wt %. In some embodiments, a second surfactant can be present in an amount of at least 0.001 wt %. In some embodiments, a second surfactant can be present in an amount of about 0.001 wt % to about 2.0 wt %, about 0.001 wt % to about 1.0 wt %, about 0.001 wt % to about 0.1% wt %, about 0.001 wt % to about 0.01 wt %, about 0.01 wt % to about 1.0 wt %, about 0.1 wt % to about 1.0 wt %, or about 0.002 wt % to about 0.008 wt %.

### Monoterpenoids

The present invention may include one or more monoterpenoids. In some embodiments, the monoterpenoid can be an acyclic, monocylic, or bicyclic monoterpenoid. In some embodiments the monoterpenoid can be one or more of carene, sabinene, camphene, thujene, camphor, borneol, eucalyptol, menthol, thymol, carvacrol, citral, citronellal, citronellol, linalool, and/or geraniol.

If present, a monoterpenoid may be present in an amount of about 0.1 wt %, about 0.2 wt %, about 0.4 wt %, about 0.6 wt %, about 0.8 wt %, about 1.0 wt %, about 1.2 wt %, about 1.4 wt %, about 1.6 wt %, or about 2.0 wt %. In some embodiments, a monoterpenoid can be present in an amount of at least 0.1 wt %. In some embodiments, a monoterpenoid can be present in an amount of about 0.1 wt % to about 2.0 wt %, about 0.1 wt % to about 1.0 wt %, about 0.1 wt % to about 0.6% wt %, about 0.6 wt % to about 1.6 wt %, about 0.6 wt % to about 2.0 wt %, about 1.6 wt % to about 2.0 wt % or about 0.1 wt % to about 4.0 wt %.

### Oils

In some embodiments, the present invention includes an oil. Suitable oils can be one or more of wintergreen, peppermint, or cinnamon oil.

If present, an oil (and if more than one oil is present, each oil) may be present in an amount of about 0.01 wt %, about 0.05 wt %, about 0.1 wt %, about 0.2 wt %, about 0.4 wt %, about 0.6 wt %, about 0.8 wt %, about 1.0 wt %, about 1.2 wt %, about 1.4 wt %, about 1.6 wt %, about 2.0 wt %, about 3 wt %, about 4 wt %, or about 5 wt %. In some embodiments, an oil can be present in an amount of at least 0.1 wt %. In some embodiments, an oil can be present in an amount of about 0.1 wt % to about 2.0 wt %, about 0.1 wt % to about 1.0 wt %, about 0.1 wt % to about 0.6% wt %, about 0.6 wt % to about 1.6 wt %, about 0.6 wt % to about 2.0 wt %, about 1.6 wt % to about 2.0 wt %, about 0.1 wt % to about 5.0 wt %, or about 0.1 wt % to about 10.0 wt %.

### Preservatives

In some embodiments, the present invention can include a preservative. In such embodiments, the preservative can be one or more of sodium benzoate, potassium sorbate, and/or methylhydroxy benzoate.

If present, a preservative can be present in an amount of about 0.1 wt %, about 0.2 wt %, about 0.4 wt %, about 0.6 wt %, about 0.8 wt %, about 1.0 wt %, about 1.2 wt %, about 1.4 wt %, about 1.6 wt %, about 2.0 wt %, about 3 wt %, about 3.5 wt %, about 4 wt %, about 4.25 wt %, about 4.5 wt %, about 4.78 wt %, about 5 wt %, about 6 wt %, about 7 wt % or about 8 wt %. In some embodiments, a preservative can be present in an amount of at least 0.1 wt %. In some embodiments, a preservative can be present in an amount of about 0.1 wt % to about 8.0 wt %, about 0.1 wt % to about 6.0 wt %, about 0.1 wt % to about 4.0 wt %, about 0.1 wt % to about 2.0 wt %, about 0.1 wt % to about 1.0 wt %, about 0.1 wt % to about 0.6% wt %, about 0.6 wt % to about 1.6 wt %, about 0.6 wt % to about 2.0 wt %, about 1.6 wt % to about 2.0 wt %, about 0.1 wt % to about 5.0 wt %, about 1.0 wt % to about 8.0 wt %, about 1.0 wt % to about 4.0 wt %, about 1.0 wt % to about 2.0 wt %, about 2.0 wt % to about 8.0 wt %, or about 4.0 wt % to about 8.0 wt %.

### Carrier

In some embodiments, the present invention may also include a carrier. Any suitable carrier can be used in the present invention, including water. In some embodiments the carrier may include an alcohol, e.g., isopropyl alcohol. The carrier will typically make up the balance by weight of the formulation of the present invention. In some embodiments, a carrier may be present in an amount of at least 10 wt %. In other embodiments, the carrier may be present in an amount of at least 90 wt %. In some embodiments, a carrier can be present in an amount of about 1 wt % to about 99 wt %, about 5 wt % to about 99 wt %, about 5 wt % to about 95% wt %, about 10 wt % to about 99 wt %, about 10 wt % to about 95 wt %, about 10 wt % to about 90 wt %, about 65 wt % to about 95 wt %, about 75 wt % to about 95 wt %, about 80 wt % to about 90 wt %, about 83 wt % to about 93 wt %, or about 20 wt % to about 80 wt %. In one embodiment, the carrier is present in an amount of about 88%. In one embodiment, the carrier is present in an amount of about 88.2 wt %. In one embodiment, the carrier is present in an amount of about 88.218%.

In some embodiments, a composition of the present invention can include additional components such as a fragrance, for example, eucalyptus lemon fragrance. In one embodiment, the fragrance is 100% pure fragrance. In other embodiments, the fragrance is about 50%, about 60%, about 70%, about 80%, about 90%, about 95%, or about 99% pure fragrance. If present, a fragrance can be present in an amount of about 0.1 wt %, about 0.2 wt %, about 0.4 wt %, about 0.6 wt %, about 0.8 wt %, about 1.0 wt %, about 1.2 wt %, about 1.4 wt %, about 1.6 wt %, or about 2.0 wt %, or in a range of about 0.1 wt % to about 5 wt %, about 0.1 wt % to about 2 wt %, about 0.1 wt % to about 1 wt %, about 0.1 wt % to about 0.5 wt %, or about 0.5 wt % to about 1.5 wt %.

In some embodiments, a composition of the present invention can include thymol, e.g., thymox concentrate 1/32, at any suitable concentration. If present, thymol can be present in an amount of about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.4 wt %, about 0.6 wt %, about 0.8 wt %, about 1.0 wt %, about 1.2 wt %, about 1.4 wt %, about 1.6 wt %, or about 2.0 wt %, or in a range of about 0.01 wt % to about 5 wt %, about 0.01 wt % to about 2 wt %, about 0.01 wt % to about 1 wt %, about 0.01 wt % to about 0.1 wt %, about 0.1 wt % to about 5 wt %, about 0.1 wt % to about 2 wt %, about 0.1 wt % to about 1 wt %, about 0.1 wt % to about 0.5 wt %, or about 0.5 wt % to about 1.5 wt %.

In some embodiments, a composition of the present invention can include NEEM, e.g., neem seed oil. In one embodiment, neem is NEEM US EPA PC code 025006. If present, neem can be present in an amount of about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.33 wt %, about 0.35 wt %, about 0.38 wt %, about 0.4 wt %, about 0.5 wt %, about 0.6 wt %, about 0.8 wt %, about 1.0 wt %, about 1.2 wt %, about 1.4 wt %, about 1.6 wt %, or about 2.0 wt %, or in a range of about 0.01 wt % to about 5 wt %, about 0.01 wt % to about 2 wt %, about 0.01 wt % to about 1 wt %, about 0.01 wt % to about 0.1 wt %, about 0.1 wt % to about 5 wt %, about 0.1 wt % to about 2 wt %, about 0.1 wt % to about 1 wt %, about 0.1 wt % to about 0.5 wt %, about 0.2 wt % to about 0.4 wt %, or about 0.5 wt % to about 1.5 wt %. In one embodiment, neem is present in an amount of about 0.33 wt %.

In some embodiments, a composition includes or consists essentially of an ester, a phenylpropanoid, a surfactant, a monoterpenoid, an oil, a preservative, and a carrier. In some embodiments, a composition includes or consists essentially of an ester, a phenylpropanoid, a surfactant, a monoterpenoid, an oil, a preservative, a fragrance, thymol, NEEM, and a carrier. In an embodiment a composition includes or consists essentially of 2-phenethyl propionate, eugenol, sodium laurel sulfate, geraniol, cinnamon oil, peppermint, coco-glucoside, sodium benzoate, eucalyptus lemon fragrance, thymol, NEEM, and deionized water.

The compositions, systems and methods of the invention may be used for coating or cleaning of a surface. The system of application may be applied daily, monthly, quarterly, as a single occurrence, or in the event of an emergency. In some embodiments two or more constituents of the present invention has a synergistic biocidal effect.

### Methods of Application

In some embodiments a method of applying a biocide of the invention or cleaning composition of the invention to a surface or substrate includes applying to the surface or substrate a composition including one or more of: (A) an ester, (B) a compound from the class of phenylpropanoids (e.g., phenylpropene or eugenol), allyl chain-substituted guaiacol, or an extract of clove oil, nutmeg, cinnamon, basil and bay leaf, (C) a first surfactant, (D) a monoterpenoid, (E) one or more oils, (F) a second surfactant, (G) a preservative, and (H) a carrier. In some embodiments the biocide composition can be applied by painting, rubbing, wiping, spraying, pouring, or any other means apparent to a person of ordinary skill in the art. In certain embodiments a method of application to a surface includes electrostatic spraying. In some embodiments, a method of application to a surface includes the use of a trigger sprayer. In one embodiment, application includes one or more trigger pulls (e.g. two, three, four, five, ten, or fifteen), from a certain distance (e.g., 6 inches).

In some embodiments, a method of application of a composition of the present invention to a surface includes applying to the surface a biocidal and/or self-cleaning composition that is about 10%, about 20%, about 30%, about 40%, about 50%, about 60%, about 70%, about 75%, about 80%, about 85%, about 90%, about 95%, about 99%, or about 100% ionized. In some embodiments where an antimicrobial agent is applied separately, the antimicrobial agent is about 10%, about 20%, about 30%, about 40%, about 50%, about 60%, about 70%, about 75%, about 80%, about 85%, about 90%, about 95%, about 99%, or about 100% ionized.

In some embodiments, and in particular embodiments where a composition of the present invention is used to clean a surface and provide a biocidal composition residue to the surface, about 0 seconds, about 15 seconds, about 30 seconds, about 1 minute, about 2 minutes, about 3 minutes, about 4 minutes, about 5 minutes, about 10 minutes, or from about 0 seconds to about 24 hours, from about 0 seconds to about 12 hours, from about 0 seconds to about 0 seconds to about 8 hours, from about 0 seconds to about 4 hours, from about 0 seconds to about 1 hour, from about 0 seconds to about 30 minutes, from about 0 seconds to about 15 minutes, from about 0 seconds to about 10 minutes, from about 0 seconds to about 5 minutes, from about 0 seconds to about 1 minutes, from about 0 seconds to about 30 seconds, from about 30 seconds to about 5 minutes, less than 24 hours, less than 12 hours, less than 8 hours, less than 4 hours, less than 1 hours, less than 30 minutes, less than 15 minutes, less than 10 minutes, less than 5 minutes, less than 1 minutes, or less than 30 seconds may elapse between application of a composition and removal of at least a portion of the composition by wiping or other techniques. In other embodiments, the composition is permitted to remain on the surface for an indefinite period or until dry.

It will be appreciated by those skilled in the art that changes could be made to the exemplary embodiments shown and described above without departing from the broad inventive concepts thereof. It is understood, therefore, that this invention is not limited to the exemplary embodiments described, but it is intended to cover modifications within the spirit and scope of the present invention as defined by the claims. For example, specific features of the exemplary embodiments may or may not be part of the claimed invention and various features of the disclosed embodiments may be combined. Unless specifically set forth herein, the terms “a”, “an” and “the” are not limited to one element but instead should be read as meaning “at least one”.

As used herein, the term “about” is understood to mean±10% of the value referenced. For example, “about 45%” is understood to literally mean 40.5% to 49.5%.

It is to be understood that at least some of the descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the methods of the present invention do not rely on the particular order of steps set forth herein, the particular order of the steps should not be construed as limitation on the claims. Any claims directed to the methods of the present invention should not be limited to the performance of their steps in the order written, and one skilled in the art can readily appreciate that the steps may be varied and still remain within the spirit and scope of the present invention.

### EXAMPLES

### Methods and Materials

In some embodiments, materials used for the compositions and methods of the invention are: Cinnamon oil (CAS: 8015-91-6, >98%), Coco Glucoside (CAS: 141464-42-8, Eugenol (CAS: 97-53-0, 99%), Eucalyptus lemon oil (lemon grass; CAS: 8000-48-4, 100%), Neem Oil (CAS: 8002-65-1, 100%), Peppermint oil (Triple distilled; CAS: 8006-90-4, >98%), Phenethyl Propionate (CAS: 122-70-3, >98%), Sodium Benzoate (CAS: 532-32-1, Dense), and Sodium Lauryl Sulfate (SLA, CAS: 151-21-3).

### Example 1

For the purpose of dilution with cleaning and disinfection products using any kind of scent in the water and any kind of disinfecting chemical or cleaner.

| Product Name | Function | Wt % |
|---|---|---|
| Water (Deionized) | Dispersant | |
| Isopropanol | | 0.0 to 1.0 wt % |
| Wintergreen oil | | 0.0 to 2.0 wt % |

### Example 2

An exemplary composition of the invention is as described in Table 1.

TABLE 1

| Component | Wt % |
|---|---|
| 2-phenethyl propionate | 0.0 to 5.0 wt % |
| Eugenol | 0.0 to 2.0 wt % |
| Sodium Laurel Sulfate | 0.0 to 2.0 wt % |
| Geraniol | 0.0 to 2.0 wt % |
| Cinnamon Oil | 0.0 to 2.0 wt % |
| Peppermint | 0.0 to 5.0 wt % |
| Coco-Glucoside | 0.0 to 1.0 wt % |
| Sodium benzoate | 0.0 to 8 wt % |
| Deionized water | Balance |

### Example 3

An exemplary composition of the invention is as described in Table 2.

TABLE 2

| Component | Wt % |
|---|---|
| 2-phenethyl propionate | 1.0 to 5.0 wt % |
| Eugenol | 0.1 to 1.0 wt % |
| Sodium Laurel Sulfate | 0.5 to 2.0 wt % |
| Geraniol | 0.01 to 0.5 wt % |
| Cinnamon Oil | 0.01 to 0.5 wt % |
| Peppermint | 0.1 to 5.0 wt % |
| Coco-Glucoside | 0.001 to 1.0 wt % |
| Sodium benzoate | 1.0 to 8 wt % |
| Deionized water | Balance |

An exemplary composition of the invention is as described in Table 3.

TABLE 3

| Component | CAS No. | Wt % |
|---|---|---|
| 2-phenethyl propionate | 122-70-3 | 1.0 to 5.0 wt % |
| Eugenol | 97-53-0 | 0.1 to 1.0 wt % |
| Sodium Laurel Sulfate | 8012-56-4 | 0.5 to 2.0 wt % |
| Geraniol | 106-24-1 | 0.01 to 0.5 wt % |
| Cinnamon Oil | 8015-91-6 | 0.01 to 0.5 wt % |
| Peppermint | 8006-90-4 | 0.1 to 5.0 wt % |
| Coco-Glucoside | 141464-42-8 | 0.001 to 1.0 wt % |
| Sodium benzoate | 532-32-1 | 1.0 to 8 wt % |
| Eucalyptus lemon fragrance | 8000-48-4 | 0.01 to 1.0 wt % |
| Thymol | | 0.01 to 1.0 wt % |
| NEEM | 80002-65-1 | 0.01 to 1.0 wt % |
| Deionized water | 7732-18-15 | Balance |

### Example 4: Direct Efficacy on Adult Bed Bugs

A composition of the invention was tested for bed bug efficacy as described herein. Direct efficacy on adult bed bugs (Cimex lectularius) was tested on three strains, one susceptible (Harlan), and two wild resistant (Cooper 2 and Nerviano 1), of adult bed bugs. Controls were untreated, while test specimens were treated with a composition of the invention (e.g., test substance: Natureal' Botanical Defense), by trigger sprayer application, i.e., one trigger pull from six inches.

Bed bug strains (test systems) used in testing include strains as described in Table 4.

TABLE 4

| Test | | | | | Jar number/ |
|---|---|---|---|---|---|
| system | Strain | Type | Stage | Source | Feed date |
| 1 | Harlan | Susceptible | Adult | Collected by | Jar #1/ |
| | | | | Harold | Jan. 13, 2016 |
| | | | | Harlan in | |
| | | | | Fort Dix, | |
| | | | | NJ, 1973 | |
| 2 | Cooper | Wild | Adult | Collected/ | Jar #3/ |
| | 2 | resistant | | Lab reared | Jan. 13, 2016 |
| 3 | Nerviano | Wild | Adult | Collected/ | Jar #1/ |
| | 1 | resistant | | Lab reared | Jan. 12, 2016 |

Treatment Arena: 1.75″ dia.×0.5″ CPVC cartridge with BioQuip 7250NSW mesh. The treatment arena was used to contain the test systems during the test substance applications.

Post-treatment arena: 35 mm Petri dish with cardboard harborage. The post-treatment arena was used to contain the test systems in a clean environment after exposure to the test sub stance.

Food/moisture: Water moistened cardboard harborage.

Volumetric measuring equipment: graduated cylinders and beakers were used as needed in preparing and/or measuring the flow rates of the test substances.

Digital balances: balances were used as needed in preparing and/or weighing the test substance canisters before and after applications.

CO₂ and Regulator: a standard 20 pound CO₂ cylinder with regulator was used to anesthetize the test systems and sort them into the test arenas (prior to exposure to the test substances). The test systems were allowed to adequately recover from anesthetizing before being exposed to the test substance, and they were not anesthetized at any point following exposure to the test substance. Any additional transfers required after exposure to the test substance was conducted using methods that did not involve anesthetizing.

Sorting/transfer containers: additional sorting and transfer containers were used to aid in moving the test systems from the primary rearing/collection containers and into the treatment and/or post-treatment arenas.

Timing equipment: A metronome and/or other timing equipment were used as needed to assist in the timing when conducting the applications and/or when collecting the observations.

Application equipment: trigger sprayer.

Test design: each treatment and post-treatment arena was labeled with a test substance code and a replicate number. The arenas were positioned on a clean tray and grouped together per test substance type. The trays with the treatment and post-treatment arenas were also labeled using the study name, trial name, and the study initiation date (as a duplicate means of ensuring accurate data collection). The test systems were sorted into the treatment arenas using the appropriate methods based on the species type. All of the test systems were confirmed to be of “good vigor” (alive) prior to exposure to the test substance. Only live test systems were selected for use in the study. After all test systems were transferred into the test arenas, they were confirmed to be alive and exhibiting normal behavior before continuing with the study.

The number of replicates conducted per test substance and the number of test systems evaluated per strain and replicate are: number of replicates per substance: 5; number of systems per replicate: 10; number of systems per substance: 50; number of test substances: 2; total number of systems: 100; and number of test arenas: 10.

Test substance application: the test substance was adequately shaken prior to applications. The applications were conducted by spraying each replicate with one pull from an approximate 6-inch distance using the mist setting that best covered the treatment area. The average flow rate and the weight of the test substance before and after application are: test substance: Natureal' Botanical Defense; flow rate (mL/pull): 0.9; pre-application weight (g): 203.9; post-application weight (g): 178.2; weight loss (g): 25.7; number of sprays: 30; and average loss (g/spray): 0.9.

Observation methods: the number of alive, knockdown (KD), and dead test systems per arena were recorded prior to applications (pre-treatment), and at 30 min, 1 hour, 2 hours, 4 hours, 24 hours, and then daily after the applications. The observations were collected by raising the test arenas and gently blowing air on the test systems to provoke movement, lightly prodding the test systems, or the test arenas were shaken/agitated to provoke test system movement. The test systems were transferred from the treatment arenas into the clean post-treatment arenas 1 hour after the applications.

Environmental conditions: the test systems were tested under ambient laboratory conditions. The average environmental conditions recorded during the study were: Application Phase: average temperature 52° F., average humidity 51%; Laboratory Phase: average temperature 70° F., average humidity 33%.

The results of this study are shown in Table 5., which illustrates the percent mortality for each bed bug (Cimex lectularius) strain. Natureal' Botanical Defense provided moderate mortality (42%-64%) with all three bed bug strains within 30 minutes after the applications, with 90% mortality recorded at days 5 (Nerviano 1 strain) and 12 (Harlan and Cooper 2 strains). The mortality rates of the specimens that were treated with Natureal' Botanical Defense were significantly higher than the untreated population mortality rates during each strain evaluation.

TABLE 5

| | Test | Pre- | Hours after treatment | | | | | Days after treatment | | | | | | | | | |
|---|---|---|---|---|---|---|---|---|---|---|---|---|---|---|---|---|---|
| Strain | Substance | trt | 0.5 | 1 | 2 | 4 | 24 | 2 | 3 | 4 | 5 | 6 | 7 | 12 | 16 | 22 | 27 |
| Harlan | Untreated | 0% | 0% | 0% | 0% | 0% | 0% | 0% | 0% | 0% | 0% | 0% | 0% | 4% | 10% | 12% | 14% |
| | controls | | | | | | | | | | | | | | | | |
| | Natureal′ | 0% | 42% | 62% | 62% | 64% | 68% | 70% | 76% | 80% | 82% | 84% | 86% | 90% | 94% | 98% | 100% |
| | Botanical | | | | | | | | | | | | | | | | |
| | Defense | | | | | | | | | | | | | | | | |
| Cooper 2 | Untreated | 0% | 0% | 0% | 0% | 0% | 0% | 0% | 0% | 0% | 0% | 0% | 0% | 2% | 2% | 8% | NA |
| | controls | | | | | | | | | | | | | | | | |
| | Natureal′ | 0% | 64% | 70% | 72% | 72% | 72% | 74% | 76% | 86% | 86% | 86% | 88% | 90% | 98% | 100% | NA |
| | Botanical | | | | | | | | | | | | | | | | |
| | Defense | | | | | | | | | | | | | | | | |
| Nerviano 1 | Untreated | 0% | 0% | 0% | 0% | 0% | 0% | 0% | 2% | 2% | 2% | 2% | 2% | 8% | 10% | 12% | NA |
| | controls | | | | | | | | | | | | | | | | |
| | Natureal′ | 0% | 58% | 56% | 56% | 58% | 58% | 70% | 80% | 88% | 90% | 91% | 96% | 98% | 100% | 100% | NA |
| | Botanical | | | | | | | | | | | | | | | | |
| | Defense | | | | | | | | | | | | | | | | |

### Example 5: Residual Efficacy on Adult Bed Bugs

A composition of the invention was tested for residual efficacy on adult bed bugs (Cimex lectularius). Controls were untreated, while test specimens were treated with a composition of the invention (e.g., test substance: Natureal' Botanical Defense), by trigger sprayer application, i.e., one trigger pull from six inches.

Bed bug strains (test systems) used in testing include strains as described in Table 6.

TABLE 6

| Test | | | | | Jar number/ |
|---|---|---|---|---|---|
| system | Strain | Type | Stage | Source | Feed date |
| 1 | Harlan | Susceptible | Adult | Collected by | Jar #1/ |
| | | | | Harold | Jan. 13, 2016 |
| | | | | Harlan in | |
| | | | | Fort Dix, | |
| | | | | NJ, 1973 | |
| 2 | Cooper | Wild | Adult | Collected/ | Jar #3/ |
| | 2 | resistant | | Lab reared | Jan. 13, 2016 |
| 3 | Nerviano | Wild | Adult | Collected/ | Jar #1/ |
| | 1 | resistant | | Lab reared | Jan. 12, 2016 |

Treatment Arena: 4″×4″ mattress ticking. The test substance was applied to the surfaces.

Cover type: 2.75″ CPVC mesh cartridge (BioQuip 7250NSW mesh). Used to contain the test systems.

Post-treatment arena: 35 mm Petri dish with cardboard harborage. The post-treatment arena was used to contain the test systems in a clean environment after exposure to the test sub stance.

Food/moisture: Water moistened cardboard harborage.

Volumetric measuring equipment: graduated cylinders and beakers were used as needed in preparing and/or measuring the flow rates of the test substances.

Digital balances: balances were used as needed in preparing and/or weighing the test substance canisters before and after applications.

CO₂ and Regulator: a standard 20 pound CO₂ cylinder with regulator was used to anesthetize the test systems and sort them into the test arenas (prior to exposure to the test substances). The test systems were allowed to adequately recover from anesthetizing before being exposed to the test substance, and they were not anesthetized at any point following exposure to the test substance. Any additional transfers required after exposure to the test substance was conducted using methods that did not involve anesthetizing.

Sorting/transfer containers: additional sorting and transfer containers were used to aid in moving the test systems from the primary rearing/collection containers and into the treatment and/or post-treatment arenas.

Timing equipment: A metronome and/or other timing equipment were used as needed to assist in the timing when conducting the applications and/or when collecting the observations.

Application equipment: trigger sprayer.

Test design: each surface type and post-treatment arena was labeled with a test substance code and a replicate number. The arenas were positioned on a clean tray and grouped together per test substance type. The trays with the surface types and post-treatment arenas were also labeled using the study name, trial name, and the study initiation date (as a duplicate means of ensuring accurate data collection). The test systems were sorted into the treatment arenas using the appropriate methods based on the species type. All of the test systems were confirmed to be of “good vigor” (alive) prior to exposure to the test substance. Only live test systems were selected for use in the study. After all test systems were transferred into the test arenas, they were confirmed to be alive and exhibiting normal behavior before continuing with the study.

The number of replicates conducted per test substance and the number of test systems evaluated per strain and replicate are similar to other experiments described herein.

### Example 6: Direct Efficacy on Bed Bug Eggs

A composition of the invention was tested for bed bug eggs efficacy as described herein. Controls were untreated, while test specimens were treated with a composition of the invention (e.g., test substance: Natureal' Botanical Defense), by trigger sprayer application, i.e., one trigger pull from six inches.

Test systems used in testing are as described in Table 7.

TABLE 7

| Test | | | | | Jar number/ |
|---|---|---|---|---|---|
| system | Strain | Type | Stage | Source | Feed date |
| 1 | Harlan | Susceptible | Eggs (2-3 | Collected | Jar #4/ |
| | | | days old) | by | Feb. 5, 2016 |
| | | | | Harold | |
| | | | | Harlan in | |
| | | | | Fort Dix, | |
| | | | | NJ, 1973 | |
| 2 | Cooper | Wild | Eggs (2-3 | Collected/ | Jar #2/ |
| | 2 | resistant | days old) | Lab reared | Feb. 5, 2016 |
| 3 | Nerviano | Wild | Eggs (2-3 | Collected/ | Jar #1/ |
| | 1 | resistant | days old) | Lab reared | Feb. 5, 2016 |

Treatment Arena: bed bug eggs attached to cardboard. The test arenas were used to contain the test systems during the test substance applications.

Post-treatment arena: 9 oz. SOLO cup snap on lid. The post-treatment arenas were used to contain the test systems in a clean environment after exposure to the test substance.

Food/moisture: None.

Volumetric measuring equipment: graduated cylinders and beakers were used as needed in preparing and/or measuring the flow rates of the test substances.

Digital balances: balances were used as needed in preparing and/or weighing the test substance canisters before and after applications.

CO₂ and Regulator: a standard 20 pound CO₂ cylinder with regulator was used to anesthetize the test systems and sort them into the test arenas (prior to exposure to the test substances). The test systems were allowed to adequately recover from anesthetizing before being exposed to the test substance, and they were not anesthetized at any point following exposure to the test substance. Any additional transfers required after exposure to the test substance was conducted using methods that did not involve anesthetizing.

Sorting/transfer containers: additional sorting and transfer containers were used to aid in moving the test systems from the primary rearing/collection containers and into the treatment and/or post-treatment arenas.

Timing equipment: A metronome and/or other timing equipment were used as needed to assist in the timing when conducting the applications and/or when collecting the observations.

Application equipment: trigger sprayer.

Test system preparation: clear rearing jars were collected for each bed bug strain evaluated and were labeled based on the study name, trial, strain, and setup date. An adequate number of cardboard sections (egg laying surfaces) were placed inside each jar. A mix of recently fed adult male and female bed bugs were placed inside each jar. Each jar was sealed with a lid and tape and was monitored for egg production daily. Once eggs were observed, the cardboard sections were removed from the jars and the total number of eggs present on each of the cardboard sections was counted. The cardboard was cut into smaller sections and/or the excess eggs were removed from each piece of cardboard so that the total number of required eggs per replicate were all on the same side/section of the cardboard. The cardboard sections were dated to note what day the eggs were present (1st day eggs were observed). The cardboard with eggs was transferred into an additional clean jar (labeled by study, trial, strain, and date setup) without bed bugs, and the eggs were removed and tested once the appropriate age was reached.

Test design: each treatment and post-treatment arena was labeled with a test substance code and a replicate number. The arenas were positioned on a clean tray and grouped together per test substance type. The trays with the treatment and post-treatment arenas were also labeled using the study name, trial name, and the study initiation date (as a duplicate means of ensuring accurate data collection). The test systems were sorted into the treatment arenas using the appropriate methods based on the species type. All of the test systems were confirmed to be viable prior to exposure to the test substance. Only cardboard sections with viable eggs were selected for use in this study.

The number of replicates conducted per test substance and the number of test systems evaluated per strain and replicate are: number of replicates per substance: 5; number of systems per replicate: 10; number of systems per substance: 50; number of test substances: 2; total number of systems: 100; and number of test arenas: 10.

Test substance application: the test substance was adequately shaken prior to applications. The applications were conducted by spraying each replicate with one pull from an approximate 6-inch distance using the mist setting that best covered the treatment area. The average flow rate and the weight of the test substance before and after application are: test substance: Natureal' Botanical Defense; flow rate (mL/pull): 0.9; pre-application weight (g): 203.9; post-application weight (g): 178.2; weight loss (g): 25.7; number of sprays: 30; and average loss (g/spray): 0.9.

Observation methods: the number of unhatched and hatched eggs was recorded, as well as the alive, knockdown (KD), and dead 1st instars. The observations were recorded prior to applications (pre-treatment) and then daily following the applications. The observations were collected by raising the test arenas and gently blowing air on the test systems to provoke movement, lightly prodding the test systems, or the test arenas were shaken/agitated to provoke test system movement. The test systems were transferred from the treatment arenas into the clean post-treatment arenas immediately after the applications.

Environmental conditions: the test systems were tested under ambient laboratory conditions. The average environmental conditions recorded during the study were: Application Phase: average temperature 53° F., average humidity 58%; Laboratory Phase: average temperature 70° F., average humidity 34%.

I/we claim:

1. A composition comprising one or more of an ester, a phenylpropanoid, a surfactant, a monoterpenoid, an oil, a preservative, and a carrier.

2. The composition of claim 1, further comprising an additional surfactant.

3. The composition of claim 1, wherein the ester is phenethyl propionate.

4. The composition of claim 1, wherein the phenylpropanoid is eugenol.

5. The composition of claim 1, wherein the surfactant is sodium laurel sulfate.

6. The composition of claim 1, wherein the monoterpenoid is geraniol.

7. The composition of claim 1, wherein the oil is cinnamon oil or peppermint oil.

8. The composition of claim 1, wherein the preservative is sodium benzoate.

9. The composition of claim 1, wherein the carrier is deionized water.

10. The composition of claim 2, wherein the additional surfactant is coco glucoside.

11. The composition of claim 1, wherein the composition is used as a biocide or a cleaning agent.

12. A composition comprising from 0.0 to 5.0 wt % 2-phenethyl propionate, from 0.0 to 2.0 wt % eugenol, from 0.0 to 2.0 wt % sodium laurel sulfate, from 0.0 to 2.0 wt % geraniol, from 0.0 to 2.0 wt % cinnamon oil, from 0.0 to 5.0 wt % peppermint, from 0.0 to 1.0 wt % coco glucoside, from 0.0 to 8.0 wt % sodium benzoate, and the balance to 100.0 wt % deionized water.

13. The composition of claim 12, comprising from 1.0 to 5.0 wt % 2-phenethyl propionate, from 0.1 to 1.0 wt % eugenol, from 0.5 to 2.0 wt % sodium laurel sulfate, from 0.01 to 0.5 wt % geraniol, from 0.01 to 0.5 wt % cinnamon oil, from 0.1 to 5.0 wt % peppermint, from 0.001 to 1.0 wt % coco glucoside, from 1.0 to 8.0 wt % sodium benzoate, and the balance to 100.0 wt % deionized water.

14. The composition of claim 13, further comprising about 0.01 wt % to about 1.0 wt % eucalyptus lemon fragrance, about 0.01 wt % to about 1.0 wt % thymol, and about 0.01 wt % to about 1.0 wt % NEEM.

15. The composition of claim 12, wherein the composition is used as a biocide for bedbugs, dust mite, spiders, fleas, ticks, mosquitoes, silver fish, and roaches.

16. A biocidal method comprising the step of applying to a surface a composition comprising an ester, a phenylpropanoid, a surfactant, a monoterpenoid, an oil, a preservative, and a carrier.

17. The method of claim 16, wherein the composition comprises from 0.0 to 5.0 wt % 2-phenethyl propionate, from 0.0 to 2.0 wt % eugenol, from 0.0 to 2.0 wt % sodium laurel sulfate, from 0.0 to 2.0 wt % geraniol, from 0.0 to 2.0 wt % cinnamon oil, from 0.0 to 5.0 wt % peppermint, from 0.0 to 1.0 wt % coco glucoside, from 0.0 to 8.0 wt % sodium benzoate, and the balance to 100.0 wt % deionized water.

18. The method of claim 17, wherein the composition comprises from 1.0 to 5.0 wt % 2-phenethyl propionate, from 0.1 to 1.0 wt % eugenol, from 0.5 to 2.0 wt % sodium laurel sulfate, from 0.01 to 0.5 wt % geraniol, from 0.01 to 0.5 wt % cinnamon oil, from 0.1 to 5.0 wt % peppermint, from 0.001 to 1.0 wt % coco glucoside, from 1.0 to 8.0 wt % sodium benzoate, and the balance to 100.0 wt % deionized water.

19. The method of claim 16, further comprising the step of removing at least a portion of the composition from the surface after a time period.

20. The method of claim 16, wherein the composition is used as a biocide for bedbugs, dust mite, spiders, fleas, ticks, mosquitoes, silver fish, and roaches.
